(19) United States
(12) Patent Application Publication
(10) Pub. No.: US 2024/0426636 A1
(43) Pub. Date: Dec. 26, 2024

(54) MAGNETIC SENSOR DEVICE AND ROTATION SENSING DEVICE

(71) Applicant: Hirose Electric Co., Ltd., Yokohama (JP)

(72) Inventor: Kosuke EGAWA, Yokohama, Kanagawa (JP)

(21) Appl. No.: 18/749,468

(22) Filed: Jun. 20, 2024

(30) Foreign Application Priority Data
Jun. 23, 2023 (JP) 2023-103483

(51) Int. Cl. G01D 5/20; G01B 7/30

(52) U.S. Cl. CPC G01D 5/20; G01B 7/30

(57) ABSTRACT

The magnetic sensor device 3 comprises a plurality of magnetic sensors 4, which have a magnetic wire rod 5 that generates a large Barkhausen effect and a coil provided at the outer periphery of the magnetic wire rod 5, and a casing 16 to which each of the plurality of magnetic sensors 4 is secured, with the plurality of magnetic sensors 4 being disposed on a reference plane coincident with the lower surface of the casing 16 at predetermined intervals in a circumferential direction about a reference line perpendicular to the reference plane, and such that the direction of extension of the magnetic wire rods 5 is parallel to the reference plane.

### BACKGROUND

### Cross-Reference to Related Applications

This application claims priority to Japanese Patent Application No. 2023-103483, filed Jun. 23, 2023, the contents of which are incorporated herein by reference in its entirety for all purposes.

### TECHNICAL FIELD

The present invention relates to a magnetic sensor device that utilizes a large Barkhausen effect, as well as to a rotation sensing device comprising said magnetic sensor device.

### RELATED ART

A magnetic sensor that utilizes a large Barkhausen effect comprises a magnetic wire rod that generates a large Barkhausen effect and a coil provided at the outer periphery of the magnetic wire rod. Specifically, a bobbin is provided in the magnetic sensor in order to fix the respective positions of the magnetic wire rod and the coil, the magnetic wire rod is disposed within the shaft portion of the bobbin, and the coil is formed by winding an electrical wire around the outer periphery of the shaft portion of the bobbin. An example of such a magnetic sensor is described in International Publication No. 2016/021074 (Patent Document 1).

For example, as described in International Publication No. 2016/021074, when magnetic sensors are used for sensing the rotation of a rotating body, such as a rotary shaft and the like, magnets are secured to the outer perimeter of the rotating body such that a rotating magnetic field is formed at the outer periphery of the rotating body upon rotation of the rotating body. In addition, a substrate is provided at the outer periphery of the rotating body so as to be free of contact with the rotating body and the magnets, and a plurality of magnetic sensors are provided on the substrate. In addition, the plurality of magnetic sensors are disposed in proximity to the rotational trajectory of the magnets in respectively different positions in the direction of rotation of the magnets. This makes it possible for the rotating magnetic field formed by the rotation of the rotating body to be sensed by the plurality of magnetic sensors and for the amount and direction of rotation, etc., of the rotating body to be sensed based on detection signals output from the coil of each magnetic sensor.

### PATENT DOCUMENTS

### [Patent Document 1]

International Publication No. 2016/021074.

### SUMMARY

### Problems to be Solved

When the rotation of a rotating body is sensed using a plurality of magnetic sensors, improving the accuracy of sensing requires a higher degree of accuracy in the relative placement of the plurality of magnetic sensors on the substrate. However, in the prior art, deviations in the relative placement of the plurality of magnetic sensors on the substrate could sometimes occur because the plurality of magnetic sensors were individually mounted to the substrate. In addition, the procedure of individually mounting a plurality of magnetic sensors to a substrate required considerable time and effort.

The present invention has been devised in view of problems including, for example, those described above, and it is an object of the present invention to provide a magnetic sensor device and a rotation sensing device which, in the process of mounting a plurality of magnetic sensors to a substrate for the purpose of sensing the rotation of a rotating body using the plurality of magnetic sensors, make it possible to minimize deviations in the relative placement of the plurality of magnetic sensors and, furthermore, make it possible to reduce the time and effort required for the mounting procedure.

### Technical Solution

In order to eliminate the above problems, the inventive magnetic sensor device comprises a plurality of magnetic sensors, which have a magnetic wire rod that generates a large Barkhausen effect and a coil provided at the outer periphery of the magnetic wire rod, and a single casing to which each of the plurality of magnetic sensors is secured, and is characterized in that the plurality of magnetic sensors are disposed on a single reference plane coincident with or parallel to the lower surface of the casing at predetermined intervals in a circumferential direction about a reference line perpendicular to the reference plane such that the direction of extension of the magnetic wire rods is parallel to the reference plane.

When the rotation of a rotating body is sensed using a plurality of magnetic sensors, magnets are secured, for example, to the outer perimeter of the rotating body, such that a rotating magnetic field is formed at the outer periphery of the rotating body upon rotation of the rotating body. In addition, a substrate is provided at the outer periphery of the rotating body so as to be free of contact with the rotating body and the magnets. The substrate is disposed such that a plane comprising the mounting face thereof is perpendicular to the axis of rotation of the rotating body. Then, the inventive magnetic sensor device is provided on the mounting face of the substrate. For example, when the inventive magnetic sensor device is provided on the mounting face of the substrate, the lower surface of the casing is placed on the mounting face of the substrate. In addition, the placement of the casing on the mounting face of the substrate is determined such that the reference line is aligned with the axis of rotation of the rotating body. Since the plurality of magnetic sensors are secured to the casing, the relative placement of the plurality of magnetic sensors on the mounting face of the substrate is determined by disposing the casing on the mounting face of the substrate. Thereafter, the casing, or each magnetic sensor, is secured to the substrate.

In the inventive magnetic sensor device, the plurality of magnetic sensors are disposed on a single reference plane coincident with or parallel to the lower surface of the casing at predetermined intervals in a circumferential direction about the reference line perpendicular to said reference plane and such that the direction of extension of the magnetic wire rods is parallel to the reference plane. Consequently, placing the lower surface of the casing on the mounting face of the substrate and determining the placement of the casing on the mounting face of the substrate such that the reference line is aligned with the axis of rotation of the rotating body allows for the plurality of magnetic sensors to be disposed on a plane coincident with or parallel to the mounting face of the substrate, allows for the plurality of magnetic sensors to be disposed at predetermined intervals in the direction of rotation of the magnets at the outer periphery of the rotational trajectory of the magnets and, furthermore, allows for the plurality of magnetic sensors to be disposed such that the direction of extension of the magnetic wire rods is parallel to the mounting face of the substrate. Namely, the placement of the plurality of magnetic sensors capable of sensing the rotation of the rotating body on the substrate can be determined simply by disposing the casing on the mounting face of the substrate in the manner described above. Therefore, when a plurality of magnetic sensors are mounted to a substrate for the purpose of sensing the rotation of a rotating body using the plurality of magnetic sensors, the inventive magnetic sensor device makes it possible to minimize deviations in the relative placement of the plurality of magnetic sensors and, furthermore, makes it possible to reduce the time and effort required for the mounting procedure in comparison to the prior art in which a plurality of magnetic sensors are individually mounted to a substrate.

In addition, the above-described inventive magnetic sensor device may comprise a plurality of yokes that control the direction of the magnetic flux of an external magnetic field, with the plurality of yokes being provided in one-to-one correspondence with the plurality of magnetic sensors, and furthermore, with the plurality of yokes being secured to the casing along with the plurality of magnetic sensors. In such a case, the plurality of yokes may be integrated with the casing by insert molding.

In order to eliminate the above-described problems, the inventive rotation sensing device is a rotation sensing device that senses the rotation of a rotating body, comprising the above-described inventive magnetic sensor device, a magnetic field forming member that rotates along with the rotating body and that forms a rotating magnetic field at the outer periphery of the rotating body upon rotation of the rotating body, and a substrate that has a mounting face and is disposed in proximity to the magnetic field forming member such that the mounting face thereof is facing up, a plane comprising the mounting face is perpendicular to the axis of rotation, and there is no contact with the rotating body and the magnetic field forming member, and characterized in that the casing of the magnetic sensor device is secured to the substrate after having been disposed on the mounting face or above the mounting face such that the reference line is aligned with the axis of rotation of the rotating body while the lower surface of the casing is parallel to the mounting face. In this rotation sensing device, the casing of the magnetic sensor device is secured to the substrate after having been disposed on the mounting face of the substrate or above the mounting face of the substrate such that the reference line is aligned with the axis of rotation of the rotating body while the lower surface of the casing is parallel to the mounting face of the substrate. Specifically, the casing is secured to the substrate after having been placed on the mounting face of the substrate such that the reference line is aligned with the axis of rotation of the rotating body while the lower surface of the casing makes contact with the mounting face of the substrate, or is secured to the substrate after having been disposed above the mounting face of the substrate such that the reference line is aligned with the axis of rotation of the rotating body while the lower surface of the casing is parallel to the mounting face of the substrate.

### Technical Effect

In accordance with the present invention, when a plurality of magnetic sensors are mounted to a substrate for the purpose of sensing the rotation of a rotating body using the plurality of magnetic sensors, deviations in the relative placement of the plurality of magnetic sensors can be minimized and, furthermore, the time and effort required for the mounting procedure can be reduced.

### BRIEF DESCRIPTION OF THE DRAWINGS

FIG. 1 is an illustrative top view of a rotation sensing device comprising a magnetic sensor device according to an inventive embodiment.

FIG. 2 is a lateral cross-sectional view of a cross-section of the rotation sensing device taken along section line II-II in FIG. 1.

FIG. 3 is a perspective view of the magnetic sensor device and the substrate according to the inventive embodiment.

FIG. 4 is an illustrative bottom view of the magnetic sensor device according to the inventive embodiment.

FIG. 5 (A) is a front, top, right perspective view of a magnetic sensor in the magnetic sensor device according to the inventive embodiment, and FIG. 5 (B) is a rear, top, right perspective view of said magnetic sensor.

FIG. 6 is a front, top, right perspective view of a bobbin in a magnetic sensor of the magnetic sensor device according to the inventive embodiment.

FIG. 7 is a front, top, right perspective view of a magnetic sensor and a yoke in the magnetic sensor device according to the inventive embodiment.

FIG. 8 is an illustrative view of a method for attaching a magnetic sensor to the casing in the magnetic sensor device according to the inventive embodiment.

FIG. 9 is an illustrative view of the placement of the magnetic sensors and yokes within the casing of the magnetic sensor device according to the inventive embodiment.

FIG. 10 is n illustrative view of the placement of the magnetic sensors and yokes within the casing of the magnetic sensor device according to the inventive embodiment.

FIGS. 11 (A) to 11 (D) are illustrative views of the magnetic field sensing operation of the magnetic sensors, etc., in the magnetic sensor device according to the inventive embodiment.

FIG. 12 is an illustrative view of a first variation of the magnetic sensor device according to the inventive embodiment.

FIG. 13 is an illustrative view of a second variation of the magnetic sensor device according to the inventive embodiment.

FIGS. 14 (A) to 14 (C) are illustrative views of a third variation of the magnetic sensor device according to the inventive embodiment.

### DETAILED DESCRIPTION

### (Rotation Sensing Device)

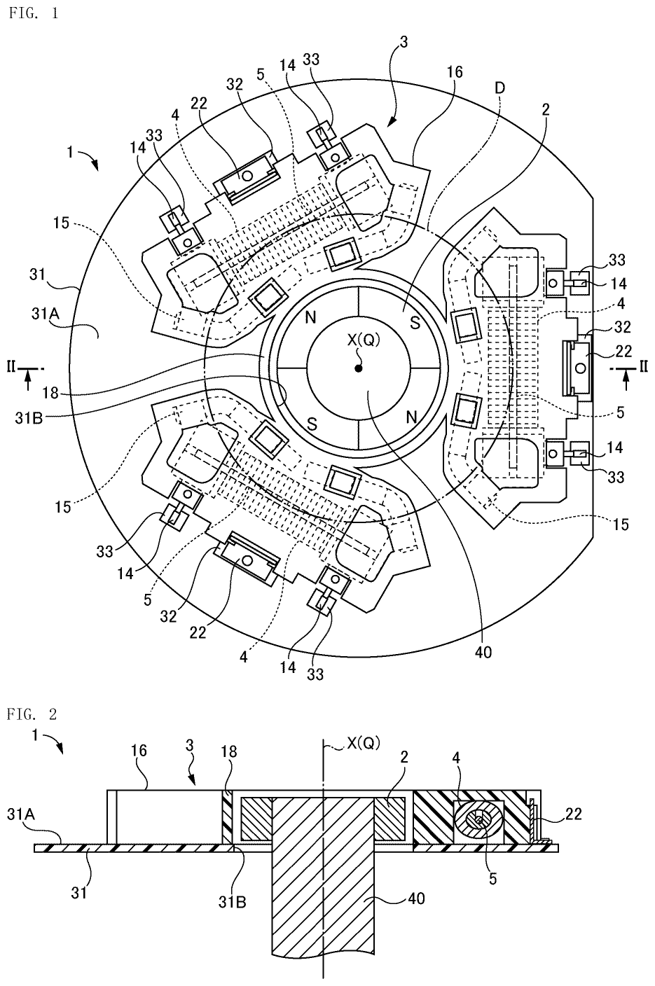

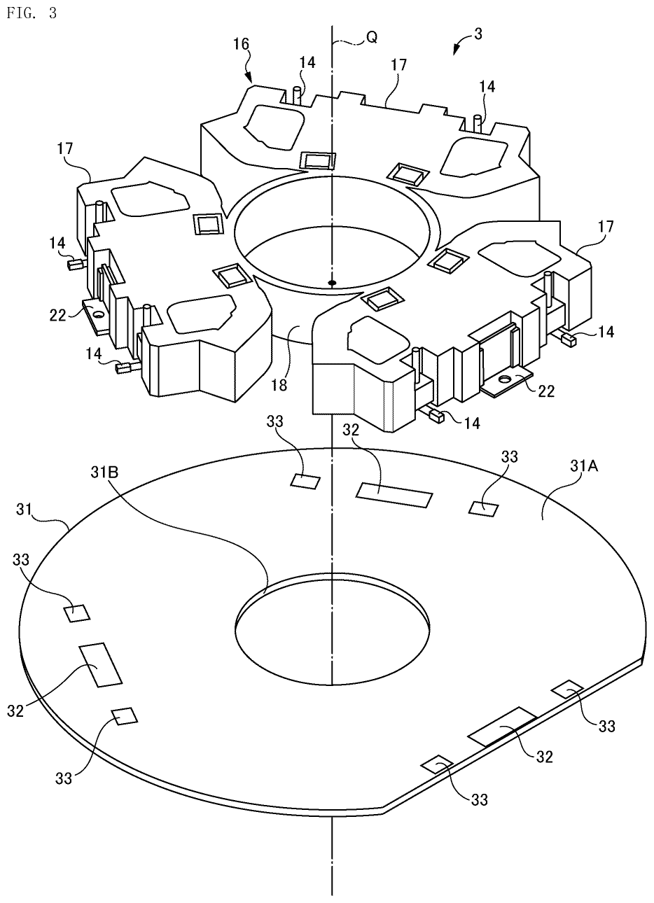

FIG. 1 is a top view of a rotation sensing device 1 comprising a magnetic sensor device 3 according to an inventive embodiment. FIG. 2 is a lateral cross-section of the rotation sensing device 1 taken along section line II-II in FIG. 1 (from below in FIG. 1).

In FIG. 1, the rotation sensing device 1 is a device that senses the rotation of a rotary shaft 40 serving as a rotating body. The rotation sensing device 1 comprises a magnetic field forming member 2 forming a rotating magnetic field, a magnetic sensor device 3 that senses the rotating magnetic field, and a substrate 31.

The magnetic field forming member 2 is formed in an annular configuration from, for example, ferrite or another magnetic material. The magnetic field forming member 2 is disposed at the outer periphery of the rotary shaft 40 coaxially with the rotary shaft 40, and is secured to the rotary shaft 40. The magnetic field forming member 2 is a multipole-magnetized magnet, with four magnetic poles, i.e., an N pole, an S pole, an N pole, and an S pole formed, in this order, in the outer peripheral section of the magnetic field forming member 2 at, for example, 90-degree intervals in the circumferential direction of the magnetic field forming member 2. It should be noted that the magnetic field forming member 2 can also be formed from four magnets without multipole magnetization.

The substrate 31 is provided at the outer periphery of the rotary shaft 40. In addition, the substrate 31 is provided in proximity to the magnetic field forming member 2. The substrate 31 is disposed such that the mounting face 31A thereof is facing up. In addition, as shown in FIG. 2, the substrate 31 is disposed such that a plane comprising the mounting face 31A is perpendicular to the axis of rotation X of the rotary shaft 40. In addition, a through hole 31B is formed in the central part of the substrate 31, and the rotary shaft 40 is inserted into the through hole 31B. The center of the through hole 31B is aligned with the center of rotation of the rotary shaft 40. In addition, the diameter of the through hole 31B is larger than the outside diameter of the rotary shaft 40, and the rotary shaft 40 does not come into contact with the substrate 31. Further, the substrate 31 is secured to the housing, and the like, of a device (e.g., a motor, etc.), in which the rotary shaft 40 is rotatably supported, through the medium of brackets and the like.

As described below, the magnetic sensor device 3 is formed by accommodating and securing three magnetic sensors 4 and three yokes 15 within a single casing 16. In FIG. 1, the three magnetic sensors 4 and three yokes 15 accommodated within the casing 16 are shown in dashed lines. The magnetic sensor device 3 is disposed on the mounting face 31A of the substrate 31 by placing the lower surface of the casing 16 on the mounting face 31A of the substrate 31 while aligning a reference line Q in the casing 16 with the axis of rotation X of the rotary shaft 40. In addition, the magnetic sensor device 3 is secured to the substrate 31 by soldering anchor fittings 22 provided in the casing 16 to anchoring pads 32 provided on the mounting face 31A of the substrate 31.

Once the magnetic sensor device 3 is disposed on the mounting face 31A of the substrate 31 in this manner, the three magnetic sensors 4 are disposed on the mounting face 31A of the substrate 31. In addition, the three magnetic sensors 4 are disposed at the outer periphery of the magnetic field forming member 2, at 120-degree intervals in the direction of rotation of the magnetic field forming member 2. In addition, each magnetic sensor 4 is disposed such that the direction of extension of the magnetic wire rod 5 is parallel to the mounting face 31A of the substrate 31. In addition, when the mounting face 31A of the substrate 31 is viewed from above, each magnetic sensor 4 is disposed such that the central part in the direction of extension of the magnetic wire rod 5 (strictly speaking, the central part in the direction of extension of the central axis of the magnetic wire rod 5) is tangential to a circle D centered about the center of rotation of the rotary shaft 40, which is drawn at the outer periphery of the magnetic field forming member 2.

In addition, once the magnetic sensor device 3 is disposed on the mounting face 31A of the substrate 31 in the manner described above, the three yokes 15 are disposed on the mounting face 31A of the substrate. The three yokes 15 are disposed in one-to-one correspondence with the three magnetic sensors 4. In addition, the three yokes 15 are disposed at the outer periphery of the magnetic field forming member 2, at 120-degree intervals in the direction of rotation of the magnetic field forming member 2. In addition, each yoke 15 is disposed so as to lie side-by-side with a magnetic sensor 4, at the inner periphery of the magnetic sensor 4.

The magnetic field forming member 2 does not come into contact with the three magnetic sensors or the three yokes. In addition, the magnetic field forming member 2 rotates along with the rotary shaft 40, whereas the magnetic sensor device 3 remains stationary. When the magnetic field forming member 2 rotates along with the rotary shaft 40, the magnetic field formed by the magnetic field forming member 2 is set into rotation. This forms a rotating magnetic field rotating about the axis of rotation X of the rotary shaft 40. The three magnetic sensors 4 sense this rotating magnetic field. Specifically, the direction of the magnetic field acting on each magnetic sensor 4 changes because of the rotation of the magnetic field formed by the magnetic field forming member 2. Each magnetic sensor 4 outputs pulse signals corresponding to the changes in the direction of this magnetic field. The amount and direction of rotation, etc., of the rotary shaft 40 can be sensed based on the pulse signals output from each magnetic sensor 4.

### (Magnetic Sensor Device)

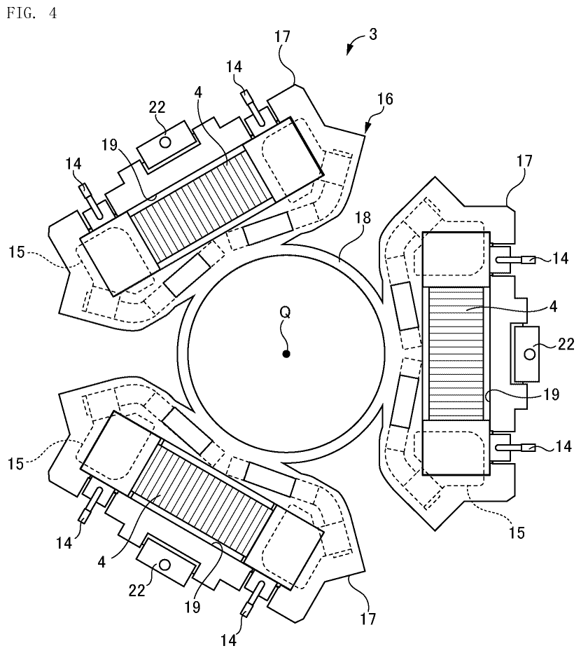

FIG. 3 is a lateral top perspective view of the magnetic sensor device 3 prior to mounting to the substrate 31 and of the substrate 31. FIG. 4 is a bottom view of the magnetic sensor device 3.

The magnetic sensor device 3 comprises three magnetic sensors 4, three yokes 15, and one casing 16. The magnetic sensor device 3 is obtained by integrating the three magnetic sensors 4 and three yokes 15 through the medium of the casing 16. As shown in FIG. 3, the three magnetic sensors 4 and three yokes 15 are accommodated and secured within the casing 16. Specifically, as shown in FIG. 4, the three magnetic sensors 4 are attached within three sensor receiving holes 19 provided in the lower surface of the casing 16. In addition, the three yokes 15 are incorporated into the casing 16. The three magnetic sensors 4 and three yokes 15 are disposed at predetermined positions within the casing 16. In addition, the three magnetic sensors 4 are identical to one another. Furthermore, the three yokes 15 are identical to one another.

### (Magnetic Sensors and Yokes)

The magnetic sensors 4 and yokes 15 will now be described. For ease of discussion, the directions associated with the magnetic sensors 4 and yokes 15, such as forward (Fd), back (Bd), up (Ud), down (Dd), left (Ld), and right (Rd) are defined as shown by the arrows drawn at the bottom right of FIGS. 5-7, 11.

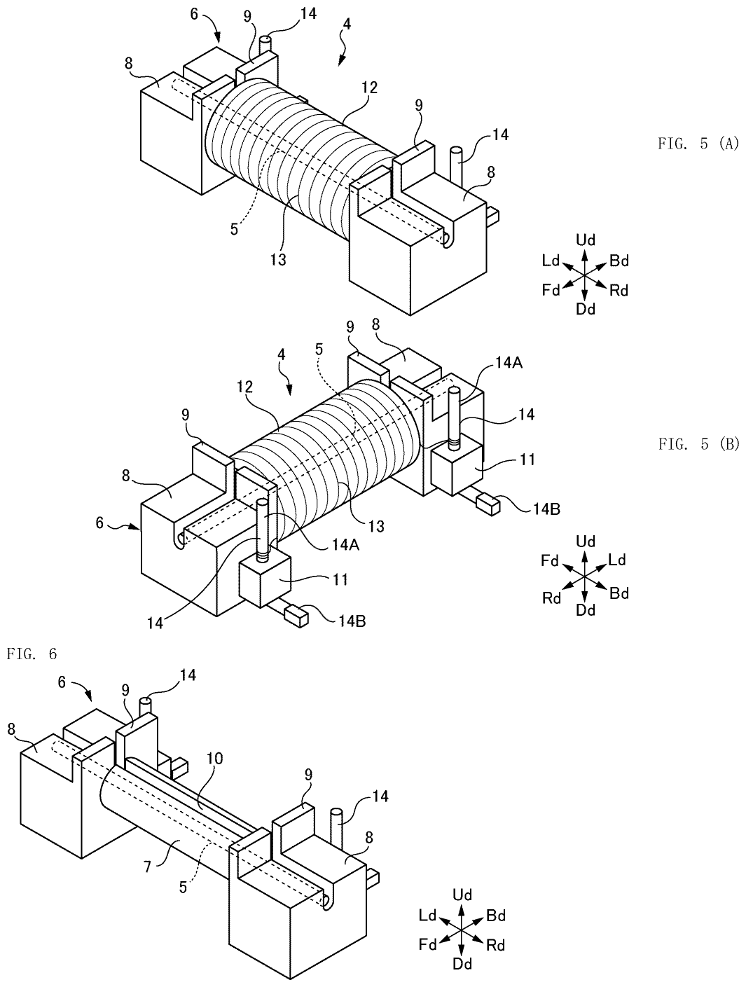

FIG. 5 (A) is a front, top, right view of one of the three magnetic sensors 4. FIG. 5 (B) is a rear top right view of the magnetic sensor 4. FIG. 6 is a front, top, right view of the bobbin 6 of the magnetic sensor 4.

In the magnetic sensor device 3, the magnetic sensors 4 are the sections that perform the sensing of the aforementioned rotating magnetic field. As shown in FIG. 5 (A), the magnetic sensor 4 comprises a magnetic wire rod 5, a bobbin 6, a coil 12, and two terminals 14.

The magnetic wire rod 5, which is a magnetic wire rod that generates a large Barkhausen effect, is called a composite magnetic wire. The magnetic wire rod 5 is a wire rod formed, for example, from a semi-rigid magnetic material containing iron and cobalt, and having a diameter of, for example, approximately 0.1 mm to 1 mm and a length of, for example, approximately 10 mm to 30 mm. The magnetic wire rod 5 is formed, for example, by drawing the above-mentioned semi-rigid magnetic material and twisting it multiple times while changing the direction. The magnetic wire rod 5 possesses uniaxial anisotropy, in which the direction of easy magnetization is the direction of the central axis of said magnetic wire rod 5. In addition, the coercivity of the magnetic wire rod 5 is higher in the central section than in the outer peripheral section thereof. The magnetic wire rod 5 possesses a property whereby the direction of magnetization of the magnetic wire rod 5 (its outer peripheral section) is abruptly reversed in response to changes in the direction of an external magnetic field.

The bobbin 6 is formed, for example, from a plastics material or another nonmagnetic material. The bobbin 6 has a bilaterally symmetrical shape. As shown in FIG. 6, the bobbin 6 comprises a wire winding portion 7, two wire rod supporting portions 8, two flange portions 9, and a wire rod receiving groove 10. The wire winding portion 7, which is provided in the left-to-right intermediate portion of the bobbin 6, is formed in a cylindrical configuration extending in a left-to-right direction. The wire rod supporting portions 8 are respectively provided at the left and right ends of the bobbin 6. The flange portions 9 are respectively provided between the wire winding portion 7 and the left wire rod supporting portion 8, and between the wire winding portion 7 and the right wire rod supporting portion 8. Each flange portion 9 is of a larger diameter than the wire winding portion 7. The wire rod receiving groove 10 is a groove that extends from the left end to the right end of the bobbin 6.

The magnetic wire rod 5 is disposed within the bobbin 6 so as to extend rectilinearly in a left-to-right direction. Specifically, the magnetic wire rod 5 is disposed within the wire rod receiving groove 10. The left end portion of the magnetic wire rod 5 is supported (secured) by the left end portion of the wire rod receiving groove 10 formed in the left wire rod supporting portion 8 by means of adhesion using adhesive agents and other means. Likewise, the right end portion of the magnetic wire rod 5 is supported (secured) by the right end portion of the wire rod receiving groove 10 formed in the right wire rod supporting portion 8. It should be noted that a wire rod receiving hole, i.e., a hole extending from the left end to the right end of the bobbin 6, may be provided instead of the wire rod receiving groove 10, and the magnetic wire rod 5 may be disposed within the wire rod receiving hole.

The coil 12 is provided at the outer periphery of the magnetic wire rod 5 disposed within the wire rod receiving groove 10. Specifically, as shown in FIG. 5 (A), the coil 12 is formed by winding an insulated wire 13, for example an enameled wire and the like, around the wire winding portion 7.

As shown in FIG. 5 (B), the two terminals 14 are respectively provided in the rear portions of the two wire rod supporting portions 8. Specifically, one terminal 14 is provided in a terminal anchoring portion 11 protruding rearwardly from the rear face of the left wire rod supporting portion 8. In addition, the other terminal 14 is provided in a terminal anchoring portion 11 protruding rearwardly from the rear face of the right wire rod supporting portion 8. Each terminal 14 is formed in an L-curved rod-like configuration from an electrically conductive material, for example a copper alloy or another metallic material. One end section of each terminal 14 is an electrical wire connecting portion 14A, and the other end section of each terminal 14 is a substrate connecting portion 14B. In each terminal 14, the electrical wire connecting portion 14A protrudes upwardly from the terminal anchoring portion 11, and the substrate connecting portion 14B protrudes rearwardly from the lower side of the terminal anchoring portion 11. One end of the insulated wire 13 is secured and electrically connected to the electrical wire connecting portion 14A of one terminal 14. The other end of the insulated wire 13 is secured and electrically connected to the electrical wire connecting portion 14A of the other terminal 14.

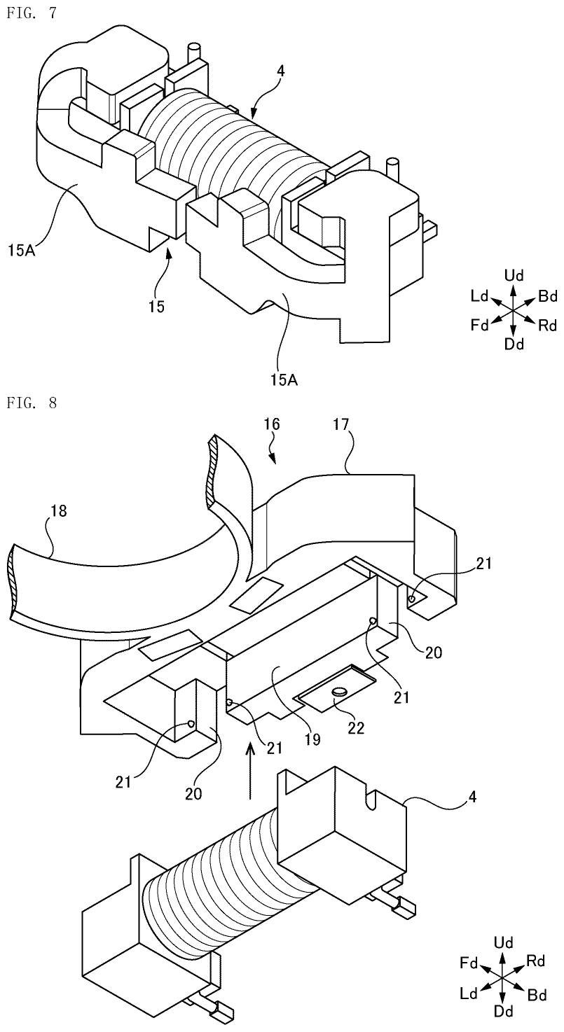

FIG. 7 is a front, top, right view of a magnetic sensor 4 and a yoke 15 corresponding to said magnetic sensor 4. The yoke 15 has the function of controlling the direction of the magnetic flux of an external magnetic field. Specifically, the yoke 15 controls the direction of the magnetic flux of the magnetic field formed by the magnetic field forming portion 2. As shown in FIG. 7, the yoke 15 comprises two yoke pieces 15A. Each yoke piece 15A is formed, for example, from iron or another soft magnetic material. A portion of one yoke piece 15A is disposed in front of the left-hand portion of the magnetic sensor 4, and another portion of the one yoke piece 15A is disposed above the left end portion of the magnetic sensor 4. In addition, a portion of the other yoke piece 15A is disposed in front of the right-hand portion of the magnetic sensor 4, and another portion of the other yoke piece 15A is disposed above the right end portion of the magnetic sensor 4.

### (Casing)

The casing 16 is formed, for example, from a plastics material or another nonmagnetic material. As shown in FIG. 3, the casing 16 has a structure obtained by coupling the three sensor holding portions 17 through the medium of a coupling portion 18. As shown in FIG. 4, one magnetic sensor 4 and one yoke 15 are accommodated and secured in each sensor holding portion 17. The shapes of the three sensor holding portions 17 are identical to one another.

FIG. 8 is a lateral bottom perspective view of one sensor holding portion 17 in the casing 16. For ease of discussion, the directions associated with the sensor holding portions 17, such as forward (Fd), back (Bd), up (Ud), down (Dd), left (Ld), and right (Rd), are defined as shown by the arrows drawn at the bottom right of FIG. 8.

As shown in FIG. 8, a sensor receiving hole 19 for receiving a magnetic sensor 4 is formed in the sensor holding portion 17. The sensor receiving hole 19, which is formed in the lower surface of the sensor holding portion 17, is downwardly open and has its top portion sealed. The shape of the opening of the sensor receiving hole 19 is a rectangle corresponding to the outer shape and size of the magnetic sensor 4 such that the magnetic sensor 4 is snugly inserted into the sensor receiving hole 19. The dimensions of the sensor receiving hole 19 in the left-to-right direction are generally equal to the dimensions of the magnetic sensor 4 in the left-to-right direction, and the dimensions of the sensor receiving hole 19 in the forward-backward direction are generally equal to the dimensions of each wire rod supporting portion 8 of the bobbin 6 of the magnetic sensor 4 in the forward-backward direction.

In addition, notches 20 are respectively formed in the left and right rear portions of the sensor holding portions 17. Upon insertion of the magnetic sensor 4 into the sensor receiving hole 19, the terminal anchoring portion 11 and terminal 14 provided in the rear portion of the left wire rod supporting portion 8 of the bobbin 6 of the magnetic sensor 4 are disposed inside the left notch 20, and the terminal anchoring portion 11 and terminal 14 provided in the rear portion of the right wire rod supporting portion 8 of the bobbin 6 of the magnetic sensor 4 are disposed inside the right notch 20.

In addition, a plurality of forwardly protruding projections 21 are formed on the rear face of the sensor receiving hole 19. Upon insertion of the magnetic sensor 4 into the sensor receiving hole 19, each projection 21 presses hard against the bobbin 6. This secures the magnetic sensor 4 in the sensor receiving hole 19. When installing the magnetic sensor 4 in the sensor holding portion 17, the operator press-fits the magnetic sensor 4 into the sensor receiving hole 19. In addition, once the magnetic sensor 4 is installed in the sensor holding portion 17 by inserting the magnetic sensor 4 deep into the sensor receiving hole 19, the lower surface of the bobbin 6 of the magnetic sensor 4 (the lower surface of each wire rod supporting portion 8) is disposed coplanar with the lower surface of the sensor holding portion 17, i.e., the lower surface of the casing 16.

In addition, anchor fittings 22 intended for securing the casing 16 to the substrate 31 are attached and secured to the lower rear portions of the sensor holding portions 17.

As shown in FIG. 3, the three sensor holding portions 17 have their front portions integrated by coupling using the coupling portion 18. In addition, the three sensor holding portions 17 have their lower surfaces disposed so as to be positioned within the same plane. In addition, when the casing 16 is viewed from above, the three sensor holding portions 17 are disposed at 120-degree intervals about the reference line Q, with the reference line Q at the center. In addition, the three sensor holding portions 17 are disposed such that the respective front portions thereof are facing toward the reference line Q. In addition, the three sensor holding portions 17 are disposed such that the sensor holding portions 17 are respectively equidistant from the reference line Q. In addition, the coupling portion 18 is formed in a cylindrical configuration and the center of the coupling portion 18 is positioned on the reference line Q. In addition, the inside diameter of the coupling portion 18 is set to a value greater than the outside diameter of the magnetic field forming member 2. In addition, in the present embodiment, the diameter of the through hole 31B in the substrate 31 is set to a value greater than the outside diameter of the magnetic field forming member 2 and the inside diameter of the coupling portion 18 is set to the same value as the diameter of the through hole 31B (see FIGS. 1 and 2). In addition, when viewed from above, the casing 16 is shaped to have rotation symmetry (three-fold symmetry) about the reference line Q.

The three magnetic sensors 4 are installed into the sensor receiving holes 19 of the three sensor holding portions 17 provided in the casing 16. In addition, in the present embodiment, the three yokes 15 are integrated with the casing 16 by insert molding. The three yokes 15 are respectively embedded into the three sensor holding portions 17. In each sensor holding portion 17, the yoke 15 is positioned in front of the sensor receiving hole 19.

(Placement of Magnetic Sensors, Etc. Within Casing)

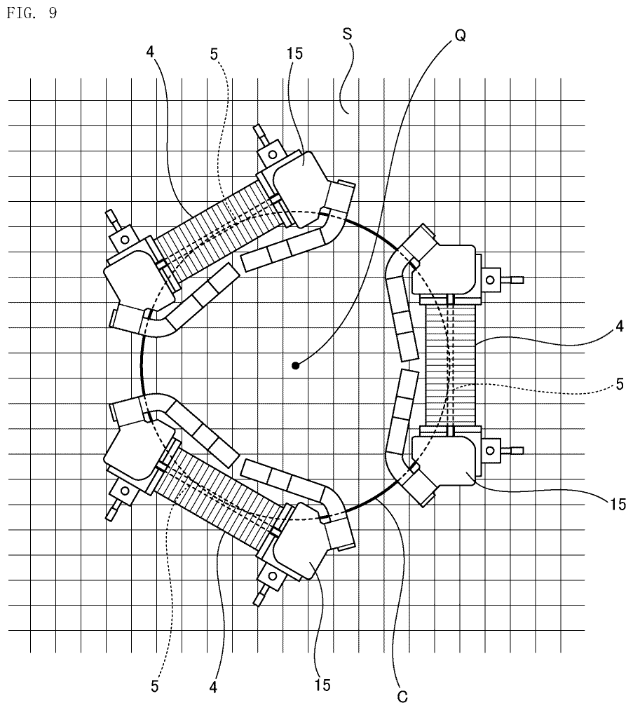

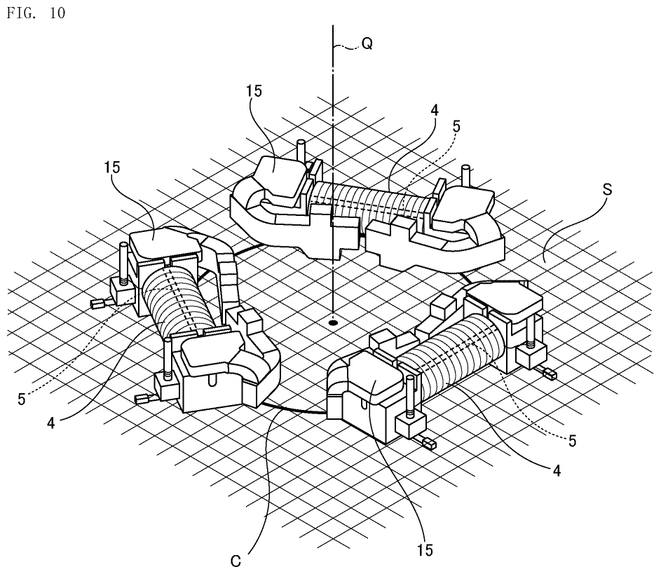

FIG. 9 is a top view of the placement of the three magnetic sensors 4 and three yokes 15 within the casing 16. FIG. 10 is a lateral top perspective view of the placement of the three magnetic sensors 4 and three yokes 15 within the casing 16. In FIG. 9 and FIG. 10, “S” shows a reference plane positioned coplanar with the lower surface of the casing 16. For convenience of illustration, the reference plane S has a grid pattern applied thereto.

As shown in FIGS. 9 and 10, within the casing 16, the three magnetic sensors 4 are disposed on the reference plane S, which is positioned coplanar with the lower surface of the casing 16. Specifically, the lower surface of each wire rod supporting portion 8 of the bobbin 6 of each magnetic sensor 4 is placed on the reference plane S. In addition, the three magnetic sensors 4 are disposed within the casing 16 at 120-degree intervals about the reference line Q perpendicular to the reference plane S. In addition, the three magnetic sensors 4 are disposed within the casing 16 such that the directions of extension of the magnetic wire rods 5 are parallel to the reference plane S. In addition, in the present embodiment, the three magnetic sensors 4 are disposed within the casing 16 such that when the casing 16 is viewed from above, the central parts in the direction of extension of the magnetic wire rods 5 (strictly speaking, the central parts in the direction of extension of the central axes of the magnetic wire rods 5) are tangential to a reference circle C. The reference circle C is a circle drawn on the reference plane S, with the center thereof located on the reference line Q. The three magnetic sensors 4 are disposed such that the front portions thereof are facing toward the reference line Q and the magnetic sensors 4 are respectively equidistant from the reference line Q. Such a placement of the three magnetic sensors 4 is obtained when the three magnetic sensors 4 are installed in the three sensor receiving holes 19 of the casing 16.

In addition, within the casing 16, the three yokes are disposed so as to lie side-by-side with the three respective magnetic sensors 4 at the inner periphery of the three magnetic sensors 4 disposed about the reference line Q. Specifically, the three yokes 15 are disposed on the reference plane S at 120-degree intervals such that the front portions thereof are facing toward the reference line Q and the yokes 15 are respectively equidistant from the reference line Q. The three yokes 15 are built into the casing 16 so as to obtain such a placement.

### (Mounting of Magnetic Sensor Device to Substrate)

The magnetic sensor device 3 comprises three magnetic sensors 4, three yokes 15, and a single casing 16, with the three magnetic sensors 4 and three yokes 15 integrated through the medium of the casing 16. Accordingly, the mounting of the magnetic sensor device 3 to the substrate 31 is generally accomplished simply by mounting the casing 16, into which the three magnetic sensors 4 and three yokes 15 have been integrated, to the mounting face 31A of the substrate 31.

When mounting the casing 16 to the mounting face 31A of the substrate 31, the operator first places the lower surface of the casing 16 on the mounting face 31A of the substrate 31 while aligning the reference line Q in the casing 16 with the axis of rotation X of the rotary shaft 40. When the lower surface of the casing 16 makes contact with the mounting face 31A of the substrate 31, the lower surface of each wire rod supporting portion 8 of the bobbin 6 of each magnetic sensor 4 simultaneously makes contact with the mounting face 31A of the substrate 31. In addition, at the same time, the lower surface of each anchor fitting 22 provided in the casing 16 makes contact with an anchoring pad 32 provided on the mounting face 31A of the substrate 31, and the lower surface of the substrate connecting portion 14B of each terminal 14 of each magnetic sensor 4 simultaneously makes contact with a connection pad 33 provided on the mounting face 31A of the substrate 31. Next, each anchor fitting 22 is soldered to an anchoring pad 32. In addition, the substrate connecting portion 14B of each terminal 14 in each magnetic sensor 4 is soldered to a connection pad 33.

As shown in FIGS. 1 and 2, by mounting the casing 16 to the mounting face 31A of the substrate 31 in this manner, the magnetic field forming member 2 is disposed inside the coupling portion 18 of the casing 16 while remaining free of contact with the coupling portion 18. Then, the position of the reference plane S shown in FIG. 9 coincides with the position of the mounting face 31A, and the three magnetic sensors 4 and three yokes 15 are disposed at the outer periphery of the magnetic field forming member 2 on the mounting face 31A of the substrate 31 while maintaining their positional relationships formed on the reference plane S.

Specifically, the three magnetic sensors 4 are disposed on the mounting face 31A of the substrate 31 as shown in FIGS. 1 and 2. The three magnetic sensors 4 are disposed at the outer periphery of the magnetic field forming member 2, at 120-degree intervals in the direction of rotation of the magnetic field forming member 2. In addition, each magnetic sensor 4 is disposed such that the direction of extension of the magnetic wire rod 5 is parallel to the mounting face 31A of the substrate 31. In addition, when the mounting face 31A of the substrate 31 is viewed from above, each magnetic sensor 4 is disposed such that the central part in the direction of extension of the magnetic wire rod 5 (strictly speaking, the central part in the direction of extension of the central axis of the magnetic wire rod 5) is tangential to a circle D centered about the center of rotation of the rotary shaft 40, which is drawn at the outer periphery of the magnetic field forming member 2. When the mounting face 31A of the substrate 31, on which the casing 16 is mounted, is viewed from above, this circle D overlaps with the reference circle C. In addition, the three yokes 15 are disposed on the mounting face 31A of the substrate. The three yokes 15 are disposed at the outer periphery of the magnetic field forming member 2, at 120-degree intervals in the direction of rotation of the magnetic field forming member 2. In addition, each yoke 15 is disposed so as to lie side-by-side with a magnetic sensor 4 at the inner periphery of the magnetic sensor 4.

In this manner, the predetermined positional relationship of the magnetic field forming member 2, three magnetic sensors 4, and three yokes 15 used for sensing the rotation of the rotary shaft 40 is determined in a conclusive manner simply by mounting the casing 16 to the mounting face 31A of the substrate 31.

### (Magnetic Field Sensing Operation of Magnetic Sensors, Etc.)

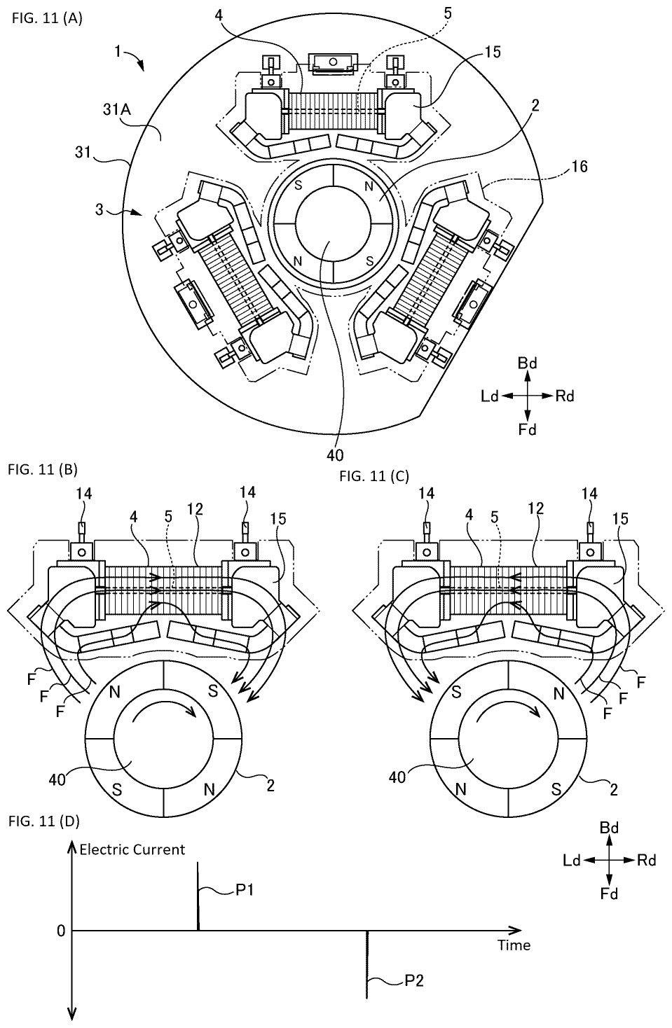

FIG. 11 (A) shows the positional relationship of the magnetic field forming member 2, three magnetic sensors 4, and three yokes 15 obtained once the magnetic sensor device 3 is provided on the substrate 31. The magnetic field sensing operation of the magnetic sensors 4 and yokes 15 will be described below by focusing on the one magnetic sensor 4 and the one yoke 15 located at the top among the three magnetic sensors 4 and three yokes 15 in FIG. 11 (A).

In FIG. 11 (A), an S pole of the magnetic field forming member 2 has approached the left front of the magnetic sensor 4 at the top, and an N pole of the magnetic field forming member 2 has approached the right front of said magnetic sensor 4. If the rotary shaft 40 rotates 90 degrees clockwise in this state, as shown in FIG. 11 (B), an N pole of the magnetic field forming member 2 approaches the left front of said magnetic sensor 4 and an S pole of the magnetic field forming member 2 approaches the right front of said magnetic sensor 4. At such time, the direction of the magnetic field acting on the magnetic wire rod 5 of said magnetic sensor 4 is to the right. This causes the direction of magnetization of the magnetic wire rod 5, which was to the left just an instant earlier, to be abruptly reversed to the right. As a result, as shown in FIG. 11 (D) for example, a positive-going current pulse P1 is generated in the coil 12.

Thereafter, if the rotary shaft 40 rotates another 90 degrees clockwise, as shown in FIG. 11 (C), an S pole of the magnetic field forming member 2 approaches the left front of said magnetic sensor 4, and an N pole of the magnetic field forming member 2 approaches the right front of said magnetic sensor 4. At such time, the direction of the magnetic field acting on the magnetic wire rod 5 of said magnetic sensor 4 is to the left. This causes the direction of magnetization of the magnetic wire rod 5, which was to the right just an instant earlier, to be abruptly reversed to the left. As a result, as shown in FIG. 11 (D) for example, a negative-going current pulse P2 is generated in the coil 12.

One end of the insulated wire 13 that forms the coil 12 is connected to a sensing circuit provided, for example, on the substrate 31, through the medium of one terminal 14 of the magnetic sensor 4 and one connection pad 33 provided on the mounting face 31A of the substrate 31. In addition, the other end of the insulated wire 13 that forms the coil 12 is connected to the aforementioned sensing circuit through the medium of the other terminal 14 of the magnetic sensor 4 and another connection pad 33 provided on the mounting face 31A of the substrate 31. With such a configuration, the electric current pulses P1, P2 generated in the coil 12 are output as pulse signals to the aforementioned sensing circuit.

The aforementioned sensing circuit senses the amount and direction of rotation, etc., of the rotary shaft 40 based on the pulse signals respectively output from the coils 12 of the three magnetic sensors 4 disposed on the mounting face 31A of the substrate 31. It should be noted that, for example, the method described in International Publication No. 2016/002437 can be used as a method of sensing the amount and direction of rotation of the rotary shaft 40 in the rotation sensing device 1.

In addition, in order to increase the level of the electric current pulses generated in the coil 12 or to sharpen the waveform of the electric current pulses, it is desirable for the magnetic flux of the magnetic field formed by the two magnetic poles of the magnetic field forming member 2 approaching the left front and right front of the magnetic sensor 4 to be focused on the magnetic wire rod 5. As shown in FIG. 11 (B) or 11 (C), a yoke 15 is disposed between the magnetic sensor 4 and the magnetic field forming member 2. The yoke 15 controls the direction of the magnetic flux such that the magnetic flux of the magnetic field formed by the two magnetic poles of the magnetic field forming member 2 approaching the left front and right front of the magnetic sensor 4 is focused on the magnetic wire rod 5. The arrows F in FIGS. 11 (B) and 11 (C) indicate the flow of the magnetic flux whose direction is controlled by the yoke 15. Since the magnetic flux is focused on the magnetic wire rod 5 by the yoke 15, the magnetic flux flows along the direction of extension of the magnetic wire rod 5 and, in addition, the magnetic flux reliably passes through the magnetic wire rod 5.

As described above, in the magnetic sensor device 3 according to the inventive embodiment, the three magnetic sensors 4 are secured in the casing 16 while the three magnetic sensors 4 are disposed on the reference plane S positioned coplanar with the lower surface of the casing 16, at 120-degree intervals about the reference line Q perpendicular to the reference plane S, such that the direction of extension of the magnetic wire rods 5 is parallel to the reference plane S and such that when the casing 16 is viewed from above, the central parts in the direction of extension of the magnetic wire rods 5 are tangential to the reference circle C. In this manner, in the magnetic sensor device 3 of the present embodiment, the relative placement of the three magnetic sensors 4 used for sensing the rotation of the rotary shaft 40 is determined and secured within the casing 16, as a result of which the relative placement of the three magnetic sensors 4 used for sensing the rotation of the rotary shaft 40 on the mounting face 31A of the substrate 31 is determined by mounting the casing 16 to the mounting face 31A of the substrate 31. Therefore, with the use of the magnetic sensor device 3 of the present embodiment, deviations in the relative placement of the three magnetic sensors 4 can be minimized in comparison to the prior art in which the three magnetic sensors are individually mounted to the substrate.

In addition, with the use of the magnetic sensor device 3 of the present embodiment, the predetermined positional relationship of the magnetic field forming member 2 and three magnetic sensors 4 used for sensing the rotation of the rotary shaft 40 is determined in a conclusive manner simply by mounting the casing 16 to the mounting face 31A of the substrate 31. Therefore, the time and effort required for the magnetic sensor mounting procedure can be reduced in comparison to the prior art which involves carrying out a procedure whereby the three magnetic sensors are individually mounted to the substrate.

In addition, in the magnetic sensor device 3 of the present embodiment, the three yokes 15, which are in one-to-one correspondence with the three magnetic sensors 4, are secured in the casing 16 along with the three magnetic sensors 4. With the use of the thus configured magnetic sensor device 3 of the present embodiment, the three yokes 15 can be disposed on the mounting face 31A of the substrate 31 and the magnetic flux of the magnetic field formed by the magnetic field forming member 2 can be focused on the magnetic wire rod 5 of each magnetic sensor 4 simply by mounting the casing 16 to the mounting face 31A of the substrate 31. Therefore, deviations in the relative placement of the yokes and magnetic sensors can be minimized and, furthermore, the time and effort required for the yoke mounting procedure can be reduced as compared to when the three yokes are individually mounted to the substrate.

In addition, in the magnetic sensor device 3 of the present embodiment, a plurality of yokes are integrated with the casing by insert molding. This allows for the yokes 15 to be rigidly secured within the casing and, furthermore, for the position of the yokes within the casing 16 to be set with precision, which makes it possible to enhance the effect of minimizing deviations in the relative placement of the yokes and magnetic sensors.

In addition, in the magnetic sensor device 3 of the present embodiment, the inside diameter of the coupling portion 18 of the casing 16 matches the diameter of the through hole 31B in the substrate 31. This allows for the position in which the casing 16 is mounted to the substrate 31 to be determined precisely by disposing the casing 16 on the mounting face 31A of the substrate 31 such that the interior surface of the coupling portion 18 and the interior surface of the through hole 31B are aligned with each other.

In addition, in accordance with the present embodiment, a rotation sensing device 1 of high rotation sensing accuracy can be readily manufactured because the placement of the magnetic field forming member 2, three magnetic sensors 4, and three yokes 15 used for sensing the rotation of the rotary shaft 40 is determined simply by mounting the casing 16 to the mounting face 31A of the substrate 31.

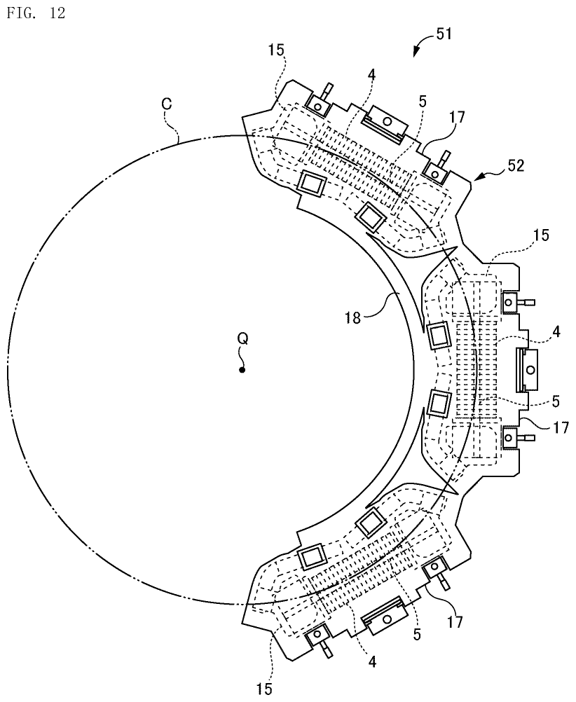

It should be noted that although the aforementioned embodiment describes an example wherein, in the casing 16 of the magnetic sensor device 3, the three magnetic sensors 4 and the three yokes 15 are disposed at 120-degree intervals, the intervals used in the placement of the three magnetic sensors and the intervals used in the placement of the three yokes 15 are not limited thereto. For example, as shown in FIG. 12, in the casing 52 of the magnetic sensor device 51, the three magnetic sensors 4 and the three yokes 15 may be disposed at 60-degree intervals.

In addition, the number of the magnetic sensors provided in the casing of the inventive magnetic sensor device is not limited to three and may also be two, four, or more. The same applies to the yokes. A configuration in which no yokes are provided within the casing of the inventive magnetic sensor device can also be used.

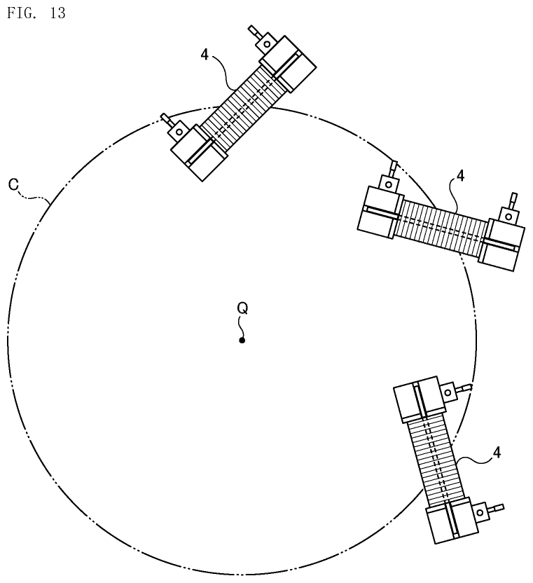

In addition, although the aforementioned embodiment describes an example wherein, in the casing 16, the three magnetic sensors 4 are disposed such that the central parts in the direction of extension of the magnetic wire rods 5 are tangential to the reference circle C when the casing 16 is viewed from above, the present invention is not limited thereto. For example, as shown in FIG. 13, the three magnetic sensors 4 may be disposed such that the magnetic wire rod 5 of each magnetic sensor 4 is transverse to the circumference of the reference circle C. It should be noted that in case of such a placement, the placement of the magnetic field forming member in the rotation sensing device (magnetic poles or magnets used to form a rotating magnetic field) will also be different. As concerns the placement of the magnetic field forming member, Japanese Patent Application Publication No. 2019-200098 can be a useful reference. In addition, still other implementations of the placement of the plurality of magnetic sensors in the inventive magnetic sensor device can also be adopted.

In addition, although the aforementioned embodiment describes an example in which the reference plane S is a plane positioned coplanar with the lower surface of the casing 16, the present invention is not limited thereto. The reference plane S may be a plane that is parallel to the lower surface of the casing 16 and is positioned upwardly or downwardly of the lower surface of the casing 16.

If the reference plane S is a plane that is parallel to the lower surface of the casing 16 and is positioned upwardly of the lower surface of the casing 16, then, upon installation of each magnetic sensor 4 in the sensor receiving holes 19 of the casing 16, the position of the lower surface of each wire rod supporting portion 8 of the bobbins 6 of the magnetic sensors 4 is above the position of the lower surface of the casing 16. As a result, when the lower surface of the casing 16 is placed on the mounting face 31A of the substrate 31, the lower surface of each wire rod supporting portion 8 of the bobbin 6 of each magnetic sensor 4 is positioned upwardly of the mounting face 31A of the substrate 31, and the substrate connecting portion 14B of each terminal 14 of each magnetic sensor 4 does not come into contact with a connection pad 33 on the mounting face 31A of the substrate 31. Accordingly, if the reference plane S is a plane positioned upwardly of the lower surface of the casing 16, the position of the substrate connecting portion 14B of each terminal 14 of each magnetic sensor 4 is lowered relative to the lower surfaces of the wire rod supporting portions 8, such that the position of the lower surface of the substrate connecting portion 14B of each terminal 14 in the up-down direction is aligned with the position of the lower surfaces of the anchor fittings 22 in the up-down direction. When the lower surface of the casing 16 is disposed on the mounting face 31A of the substrate 31, this allows the substrate connecting portion 14B of each terminal 14 of each magnetic sensor 4 and each anchor fitting 22 to simultaneously make contact with the respective connection pad 33 and anchoring pad 32 on the mounting face 31A of the substrate 31 and makes it possible for the substrate connecting portion 14B of each terminal 14 of each magnetic sensor 4 and each anchor fitting 22 to be soldered to the respective connection pad 33 and anchoring pad 32.

On the other hand, if the reference plane S is a plane that is parallel to the lower surface of the casing 16 and is positioned downwardly of the lower surface of the casing 16, then, upon installation of each magnetic sensor 4 in the sensor receiving holes 19 of the casing 16, the position of the lower surface of each wire rod supporting portion 8 of the bobbins 6 of the magnetic sensors 4 is lower than the position of the lower surface of the casing 16. As a result, when the casing 16 is mounted to the mounting face 31A of the substrate 31, the lower surface of each wire rod supporting portion 8 of the bobbin 6 of each magnetic sensor 4 is placed on the mounting face 31A of the substrate 31. At such time, the lower surface of the casing 16 is disposed above the mounting face 31A of the substrate 31 and in parallel with the mounting face 31A of the substrate 31. As a result, none of the anchor fittings 22 of the casing 16 makes contact with the anchoring pads 32 on the mounting face 31A of the substrate 31. Accordingly, if the reference plane S is a plane positioned downwardly of the lower surface of the casing 16, the bottom portion of each anchor fitting 22 is lowered relative to the lower surface of the casing 16 such that the position of the lower surfaces of the anchor fittings 22 in the up-down direction is aligned with the position of the lower surface of the substrate connecting portion 14B of each terminal 14 in the up-down direction. When the lower surface of each wire rod supporting portion 8 of each magnetic sensor 4 is placed on the mounting face 31A of the substrate 31, this allows the substrate connecting portion 14B of each terminal 14 of each magnetic sensor 4 and each anchor fitting 22 to simultaneously make contact with the respective connection pad 33 and anchoring pad 32 on the mounting face 31A of the substrate 31, and makes it possible for the substrate connecting portion 14B of each terminal 14 of each magnetic sensor 4 and each anchor fitting 22 to be soldered to the respective connection pad 33 and anchoring pad 32.

In addition, although in the aforementioned embodiment the casing 16 (52) of the magnetic sensor device 3 (51) is a structure in which three sensor holding portions 17 are coupled through the medium of a coupling portion 18, the structure of the casing of the inventive magnetic sensor device is not limited thereto and, for example, may have a one-piece block-like or plate-like configuration.

In addition, although the aforementioned embodiment describes an example wherein the three magnetic sensors 4, three yokes 15, and the casing 16 are provided on the substrate 31 by placing the casing 16, which has the three magnetic sensors 4 and three yokes 15 secured thereto, on the substrate 31 and securing it to the substrate 31, the present invention is not limited thereto. For example, after disposing the casing 16 having the three magnetic sensors 4 and three yokes 15 detachably secured thereto on the substrate 31, each magnetic sensor 4 and each yoke 15 may be rigidly secured to the substrate 31, but the casing 16 may be left unsecured to the substrate 31 and, after rigidly securing each magnetic sensor 4 and each yoke 15 to the substrate 31, the casing 16 may be removed from the substrate 31 while leaving the three magnetic sensors 4 and three yokes 15 on the substrate 31.

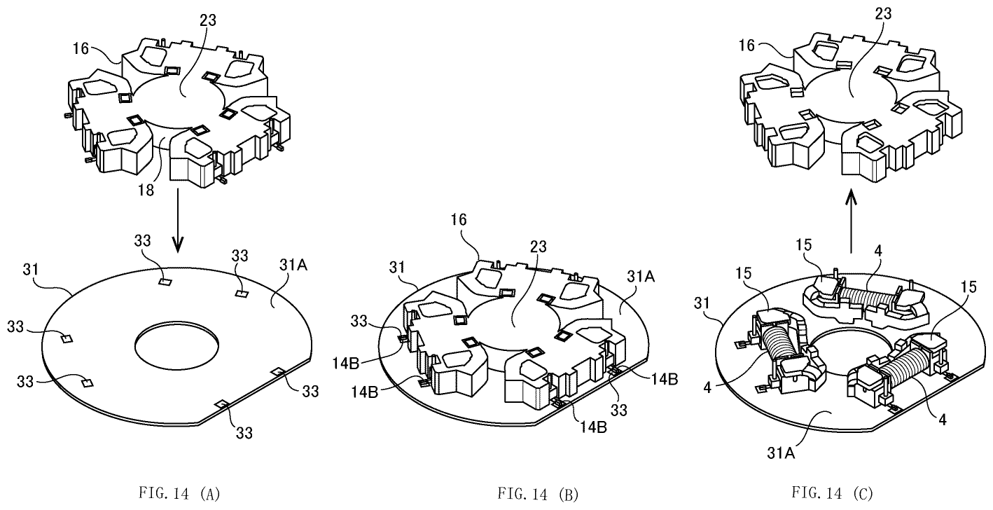

In such a case, for example, a yoke 15 is secured to each of the three magnetic sensors 4 in a manner preventing ready separation, and the three magnetic sensors 4 having a yoke 15 secured thereto are secured within the three sensor receiving holes provided in the lower surface of the casing 16 in a manner permitting ready separation. When the rotation sensing device is assembled, first, as shown in FIG. 14 (A), the casing 16, to which the three magnetic sensors 4 having a yoke 15 secured thereto have been secured in a manner permitting ready separation, is placed on the mounting face 31A of the substrate 31. Next, as shown in FIG. 14 (B), the substrate connecting portion 14B of each terminal 14 of each magnetic sensor 4 is soldered to a connection pad 33 on the mounting face 31A of the substrate 31. The three magnetic sensors 4 having a yoke 15 secured thereto are thus rigidly secured to the substrate 31. Next, as shown in FIG. 14 (C), the casing 16 is pulled up and away from the substrate 31. This separates the casing 16 from the three magnetic sensors 4 soldered to the substrate 31 and from the three yokes 15 respectively secured to three magnetic sensors 4 in a manner preventing ready separation, thereby leaving the three magnetic sensors 4 and three yokes 15 on the mounting face 31A of the substrate 31. For example, a method involving adhering a yoke 15 to each wire rod supporting portion 8 of the bobbin 6 of the magnetic sensor 4 using an adhesive agent can be used as a method for securing a yoke 15 to each of the three magnetic sensors 4 in a manner preventing ready separation. In addition, the sensor receiving holes formed in the lower surface of the casing 16 are made larger than the sensor receiving holes 19 according to the aforementioned embodiment so as to permit installation of magnetic sensors 4 having a yoke 15 secured thereto into the casing 16. In addition, for example, in order to make the magnetic sensors 4 having a yoke 15 secured thereto and the casing 16 easily separable from each other, the height of each projection formed on the rear faces of the sensor receiving holes of the casing 16 is made smaller than that of the projections 21 according to the embodiment, which makes it easier for the magnetic sensors 4 having a yoke 15 secured thereto to be removed from the sensor receiving holes. In addition, since the casing 16 is removed from the substrate 31 after soldering the three magnetic sensors 4 having a yoke 15 secured thereto to the substrate 31, no anchor fittings 22 are provided in the casing 16. In addition, when components are mounted to a substrate, a mounting device equipped with a suction nozzle may be used in order to move and place, etc., the components on the substrate. As shown in FIG. 14 (A), it is desirable to seal the top of the coupling portion 18 of the casing 16 and form a suction surface 23 in the middle of the upper face of the casing 16 for adhering the casing 16 to the suction nozzle by suction.

In addition, the present invention can be modified as appropriate where consistent with the essence or concept of the invention read from the claims and the specification in its entirety, and magnetic sensor devices and rotation sensing devices featuring such modifications are also included within the technical concept of the present invention.

### DESCRIPTION OF THE REFERENCE NUMERALS

1 Rotation sensing device
2 Magnetic field forming member
3, 51 Magnetic sensor device
4 Magnetic sensor
5 Magnetic wire rod
12 Coil
15 Yoke
16, 52 Casing
31 Substrate
31A Mounting face
40 Rotary shaft (rotating body)
Q Reference line
S Reference plane

1. A magnetic sensor device, comprising:
a plurality of magnetic sensors, which have a magnetic wire rod that generates a large Barkhausen effect and a coil provided at an outer periphery of the magnetic wire rod, and
a single casing to which each of the plurality of magnetic sensors is secured,
wherein the plurality of magnetic sensors are disposed on a single reference plane coincident with or parallel to a lower surface of the casing at predetermined intervals in a circumferential direction about a reference line perpendicular to the reference plane and such that a direction of extension of the magnetic wire rods is parallel to the reference plane.

2. The magnetic sensor device according to claim 1, comprising:
a plurality of yokes that control the direction of the magnetic flux of an external magnetic field,
wherein the plurality of yokes are provided in one-to-one correspondence with the plurality of magnetic sensors, and
the plurality of yokes are secured to the casing along with the plurality of magnetic sensors.

3. The magnetic sensor device according to claim 2, wherein the plurality of yokes are integrated with the casing by insert molding.

4. A rotation sensing device that senses the rotation of a rotating body, comprising:
the magnetic sensor device according to claim 1,
a magnetic field forming member that rotates along with the rotating body and that forms a rotating magnetic field at the outer periphery of the rotating body upon rotation of the rotating body, and
a substrate that has a mounting face and is disposed in proximity to the magnetic field forming member such that the mounting face thereof is facing up, a plane comprising the mounting face is perpendicular to the axis of rotation and, in addition, there is no contact with the rotating body or the magnetic field forming member,
wherein the casing of the magnetic sensor device is secured to the substrate after having been disposed on the mounting face or above the mounting face such that the reference line is aligned with the axis of rotation of the rotating body and, in addition, the lower surface of the casing is parallel to the mounting face.
